(19) United States
(12) Patent Application Publication
(10) Pub. No.: US 2015/0232028 A1
(43) Pub. Date: Aug. 20, 2015

(54) Exterior Mirror Blind Spot Warning Display and Video Camera

(71) Applicant: Magnadyne Corporation, Compton, CA (US)

(72) Inventor: Patrick G. Reardon, Coto de Caza, CA (US)

(73) Assignee: Magnadyne Corporation, Compton, CA (US)

(21) Appl. No.: 14/180,936

(22) Filed: Feb. 14, 2014

(51) Int. Cl. B60R 1/00

(52) U.S. Cl. CPC B60R 1/00; B60R 2300/802; B60R 2300/105; B60R 2300/202

(57) ABSTRACT

A blind spot detection system having a sensor system in a vehicle for detecting the presence of other vehicles in blind spot areas behind and to the side of the vehicle. The sensor system provides a signal to a visual alert display device and an audible alarm to warn a driver of the vehicle in one or more of the blind spot areas. A video camera and the visual alert display device are disposed within the housing of an exterior mirror assembly. The video camera provides video display data to a video display screen to provide the driver with a video image of the second vehicle when a turn signal actuator is actuated to provide a turn signal actuation signal.

### TECHNICAL FIELD

This disclosure relates to a method and a system for warning of the presence of another vehicle in the blind spot of a vehicle and providing a display of the blind spot area from a video camera disposed in the exterior mirror housing.

### BACKGROUND

Vehicles, particularly large vehicles such as trucks and recreational vehicles, have a blind spot behind and to the side of the vehicle that is not observable by a driver directly or with the interior rear view mirror or the exterior rearview mirror.

This disclosure is directed to solving the above problem and other problems as summarized below.

### SUMMARY

According to one aspect of this disclosure, a blind spot detection and display system is disclosed for a vehicle. The system includes an exterior mirror assembly including a housing and a mirror. A video camera is assembled to the exterior mirror. A sensor is assembled to the vehicle that detects the presence of a second vehicle in a blind spot location behind and beside the vehicle. A visual alert display device is attached to the housing that is actuated by a signal received from the sensor when the second vehicle is located in the blind spot location. A video display screen visible to a driver of the vehicle and capable of being activated by a signal received from a turn signal actuator.

According to other aspects of the system, the visual alert display device may be a light source disposed within the housing and visible on the surface of the mirror and wherein the video camera is at least partially disposed within the housing. The light source may be a ring-shaped light that encircles a lens of the video camera. The visual alert display device may be illuminated when a second vehicle is in the blind spot location. An audible alarm may be sounded when the detection signal is received from the sensor.

The sensor may be a radar sensor system or an ultrasonic sensor system. The sensor may include a first sensor attached proximate a right rear corner of the vehicle and a second sensor attached proximate a left rear corner of the vehicle.

The video display screen may be disposed on a dashboard of the vehicle or in another location that is visible to a driver of the vehicle. The video display screen may project an image received from the video camera when a turn signal is actuated to provide a second signal or a manual selector switch is actuated to provide a third signal to the video display screen.

According to another aspect of the system, the exterior mirror assembly may further comprise a right side exterior mirror and a left side exterior mirror that each includes the video camera and the visual alert display device. The sensor may include a first sensor attached near a right rear corner of the vehicle and a second sensor attached near a left rear corner of the vehicle. A second vehicle may be detected by the first sensor that actuates the visual alert display device in the right side exterior mirror, or when the second vehicle is detected by the second sensor that actuates the visual alert display device in the left side exterior mirror.

According to another aspect of this disclosure, a method is disclosed for informing a driver of a vehicle as to the presence of a second vehicle in a blind spot location behind and beside the vehicle. The method comprises detecting the second vehicle in the blind spot and generating a detection signal. A visual alert display device on or in an exterior mirror is actuated in response to receiving the detection signal. A video display screen for displaying an image received from a video camera disposed on or in the exterior mirror is actuated in response to receiving a turn signal actuation signal. The image from the video camera may not be displayed when the turn signal actuation signal is not being generated.

According to other aspects of the method, the visual alert display device may be a light source disposed within the housing and visible on the surface of the mirror. The video camera is disposed within the housing and includes a lens that is directed through the surface of the mirror. The light source may be a ring-shaped light that encircles a lens of the video camera. The visual alert display device may be illuminated when a second vehicle is in the blind spot location.

The sensor may include a first sensor attached proximate a right rear corner of the vehicle and a second sensor attached proximate a left rear corner of the vehicle.

The method may further comprise an audible alarm and the method may further include actuating the audible alarm in response to the detection signal. The method may also be practiced with a right side exterior mirror and a left side exterior mirror, wherein each exterior mirror includes the video camera and the visual alert display device. The sensor may include a first sensor attached adjacent a right rear corner of the vehicle and a second sensor attached adjacent a left rear corner of the vehicle. When a second vehicle is detected by the first sensor, the visual alert display device in the right side exterior mirror is actuated. When a second vehicle is detected by the second sensor, the visual alert display device in the left side exterior mirror is actuated.

According to another aspect of this disclosure, a vehicle accessory is disclosed that comprises a right side exterior mirror attached to a right side of a vehicle, and a left side exterior mirror attached to a left side of the vehicle, wherein each exterior mirror includes a housing and a mirror. A sensor system includes a first sensor oriented to sense an area proximate a right rear corner of the vehicle and a second sensor oriented to sense an area proximate a left rear corner of the vehicle. First and second video cameras are assembled to the right and left side exterior mirrors. A visual alert display device is attached to each of the housings that is actuated by a signal received from one of the sensors that detects the presence of a second vehicle in one of the areas proximate the right rear corner or the left rear corner. A video display screen visible to a driver of the vehicle is actuated by a turn signal actuation signal. When a second vehicle is detected by the first sensor, the visual alert display device in the right side exterior mirror is actuated. When a second vehicle is detected by the second sensor, the visual alert display device in the left side exterior mirror is actuated.

The visual alert display device is illuminated when a second vehicle is in the blind spot location. The video display screen projects an image received from one of the video cameras when the turn signal actuation signal is received and does not project an image when no turn signal actuation signal is received.

The vehicle accessory may be integrated with an audible alarm that is actuated in response to the detection signal. The vehicle accessory may also include a selector switch for selectively actuating the video cameras.

The above aspects of this disclosure and other aspects are described below in greater detail with reference to the attached drawings.

### BRIEF DESCRIPTION OF THE DRAWINGS

FIG. 1 is a diagrammatic top plan view of an integrated blind spot detection and display system for a vehicle that is made according to one embodiment of the disclosed system.

FIGS. 2a and 2b are close-up perspective views of the left and right exterior mirrors.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

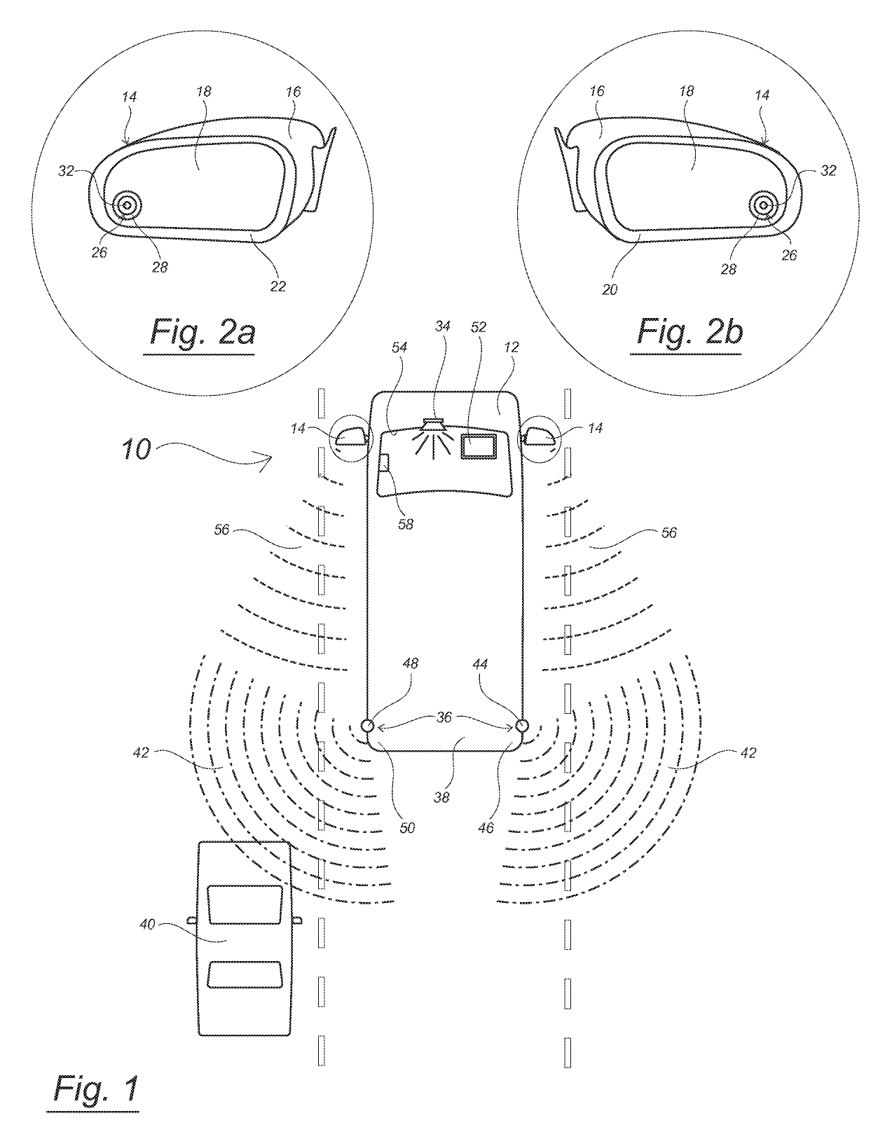

Referring to FIG. 1, a blind spot detection system 10 for a vehicle 12 is diagrammatically illustrated that includes an exterior mirror assembly 14.

Referring to FIGS. 1, 2a and 2b, the exterior mirror assembly is shown to include a housing 16 and a mirror 18. The exterior mirror 14 is attached to an exterior part or panel of the vehicle and is used to observe other vehicles or objects to the side and rear of the vehicle 12. A right side mirror 20 and a left side mirror 22 are attached to right and left sides of the vehicle 12, respectively. Even when properly adjusted, exterior mirror assemblies 14 do not provide a full view and blind spots remain in which surrounding vehicles may not be noticed. Blind spots are larger and more prevalent with large vehicles such as trucks and recreational vehicles.

The blind spot detection system 10 includes a video camera 26 in the right and left side mirrors 20 and 22. The video camera 26 is disposed within the housing 16 and is oriented to face in a rearward direction to provide a video image of an area to the side of the vehicle behind the mirror 18 and the vehicle 12. The video image is provided to reduce or eliminate blind spots for a driver of the vehicle.

A visual alert display device 28 is also provided within the housing 16 that provides a visually observable alert that is visible on the surface of the mirror 18. The visual alert display device may be a light source such as a light bulb or a light emitting diode (LED). In one embodiment, the visual alert display device may be a ring-shaped LED that is disposed around a lens 32 of the video camera 26.

The blind spot detection system 10 may also include an audible alarm 34 that emits a sound to alert a driver to the presence of a vehicle in a blind spot. The audible alarm may be a dedicated alarm for the system 10 or it may be an alarm that is part of another warning system of the vehicle. The presence of a second vehicle 40 in a blind spot is detected by a sensor system 36 disposed in a rear portion 38 of the vehicle 12. The sensor system 36 may be a radar system, an ultrasonic system, or the like, that is configured to detect the second vehicle 40 in a blind spot location 42 beside and to the rear of the vehicle 12 and either on the right side or the left side of the vehicle 12.

The sensor system 36 may include a first sensor 44 that is disposed proximate a right rear corner 46 in the rear portion 38 of the vehicle 12. A second sensor 48 is disposed proximate a left rear corner 50 in the rear portion 38 of the vehicle 12. The first and second sensors 46 and 50 utilize well known radar or ultrasonic technology to detect the presence of the second vehicle 40 in blind spot areas as indicated by the arcuate lines 42 in FIG. 1 to the rear and right and left sides of the vehicle 12.

When the sensor system 36 detects the second vehicle 40 in a blind spot area, a signal is provided to the blind spot detection system 10 that illuminates the visual alert display device 28. The signal may also actuate the audible alarm 34 to alert the driver of the vehicle 12 even if the driver is not looking at the exterior mirrors. The visual alert display device 28 and/or the audible alarm 34 may be overridden if the driver prefers as matter of personal preference or if the vehicle is being operated in heavy traffic.

A signal from a turn signal actuator is used to actuate the video camera 26 in either the right side mirror 20 or the left side mirror 22 depending upon whether the turn signal actuator is indicating a turn to the right or left or an anticipated change of lanes. The video camera provides video data to a video display screen 52 that is located on the dashboard 54 of the vehicle 12. Alternatively, the video display screen could be a heads-up display provided in the windshield, or a video display screen provided on or near the exterior mirror assembly or the interior rear view mirror.

The video camera 26 provides a visual image within a field of view that is generally indicated by the arcuate lines 56 in FIG. 1 that emanate from the exterior mirrors 14.

The visual alert display device 28 and audible alarm 34 are both deactivated when the second vehicle 40 that was detected is no longer in the blind spot areas 42. In the event a third vehicle (not shown) is detected in one of the blind spot areas 42, the sensor system 36 may again provide a signal to the blind spot detection system 10 to reactivate the visual alert display device 28 and audible alarm 30, switch to the opposite visual alert display device, or continue to operate the system even though the second vehicle is no longer in the blind spot area 42.

The blind spot detection system 10 may also include other inputs such as a minimum speed input that may be used to prevent the system from providing alerts when the vehicle is travelling at less than a predetermined speed, for example, when the vehicle 12 is in slow or stopped traffic.

The video display screen 52, as described above, only provides a video display of one side of the vehicle 10 depending upon what side the turn signal is indicating. Alternatively, the video display screen 52 may be manually controlled by a manual selector switch 58 to provide a display from one or both video cameras 26 in a full, partial or half-screen display.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A blind spot detection and display system for a vehicle, comprising:
an exterior mirror assembly including a housing and a mirror;
a video camera assembled to the exterior mirror assembly;
a sensor assembled to the vehicle that detects a presence of a second vehicle in a blind spot location behind and beside the vehicle;
a visual alert display device attached to the exterior mirror assembly that is actuated by a first signal received from the sensor when the second vehicle is located in the blind spot location; and
a video display screen visible to a driver of the vehicle that is actuated by a second signal received from a turn signal actuator.

2. The system of claim 1 wherein the visual alert display device is a light source disposed within the housing and visible on a surface of the mirror, and wherein the video camera is at least partially within the housing.

3. The system of claim 2 wherein the light source is a ring-shaped light that encircles a lens of the video camera, wherein the lens is directed toward the blind spot location.

4. The system of claim 1 wherein the sensor is a radar sensor system.

5. The system of claim 1 wherein the sensor is an ultrasonic sensor system.

6. The system of claim 1 wherein the sensor includes a first sensor attached adjacent a right rear corner of the vehicle and a second sensor attached adjacent a left rear corner of the vehicle.

7. The system of claim 1 wherein the video display screen is disposed on a dashboard of the vehicle.

8. The system of claim 1 wherein the visual alert display device is illuminated when a second vehicle is in the blind spot.

9. The system of claim 1 wherein the video display screen projects an image received from the video camera when a manual selector switch is actuated to provide a third signal to the video display screen.

10. The system of claim 1 wherein the exterior mirror assembly further comprises:
a right side exterior mirror and a left side exterior mirror, wherein each exterior mirror includes the video camera and the visual alert display device;
wherein the sensor includes a first sensor attached proximate a right rear corner of the vehicle and a second sensor attached proximate a left rear corner of the vehicle; and
wherein when a second vehicle is detected by the first sensor the visual alert display device in the right side exterior mirror is actuated, and wherein when a second vehicle is detected by the second sensor the visual alert display device in the left side exterior mirror is actuated.

11. The system of claim 1 further comprising an audible alarm that is actuated by the first signal received from the sensor.

12. A method of informing a driver of a vehicle of a presence of a second vehicle in a blind spot location behind and beside the vehicle, comprising:
detecting the second vehicle in the blind spot and generating a detection signal;
actuating a visual alert display device on an exterior mirror in response to receiving the detection signal; and
actuating a video display screen in response to receiving a turn signal actuation signal to display an image received from a video camera disposed on the exterior mirror that is visible to the driver.

13. The method of claim 12 wherein the visual alert display device is a light source disposed within the exterior mirror and visible on a surface of the mirror and, wherein the video camera is disposed within the housing and includes a lens that is direct through the surface of the mirror.

14. The method of claim 13 wherein the light source is a ring-shaped light that encircles a lens of the video camera.

15. The method of claim 12 wherein the step of detecting the second vehicle is performed by a first sensor attached adjacent a right rear corner of the vehicle and a second sensor attached adjacent a left rear corner of the vehicle.

16. The method of claim 12 wherein the video display screen is disposed on a dashboard of the vehicle.

17. The method of claim 12 wherein the visual alert display device is illuminated when a second vehicle is in the blind spot location and is not illuminated when a second vehicle is not in the blind spot location.

18. The method of claim 12 further comprising an audible alarm and the method includes actuating the audible alarm in response to the detection signal.

19. The method of claim 12 wherein the exterior mirror further comprises:
a right side exterior mirror and a left side exterior mirror, wherein each exterior mirror includes the video camera and the visual alert display device;
wherein the step of detecting the second vehicle is performed by a first sensor attached adjacent a right rear corner of the vehicle and a second sensor attached adjacent a left rear corner of the vehicle; and
wherein when the second vehicle is detected by the first sensor the visual alert display device in the right side exterior mirror is actuated, and wherein when the second vehicle is detected by the second sensor the visual alert display device in the left side exterior mirror is actuated.

20. A vehicle accessory comprising:
a right side exterior mirror attached to a right side of a vehicle;
a left side exterior mirror attached to a left side of the vehicle, wherein each exterior mirror includes a housing and a mirror;
a sensor system including a first sensor oriented to sense a first blind spot location area proximate a right rear corner of the vehicle and a second sensor oriented to sense a second blind spot location area proximate a left rear corner of the vehicle;
a visual alert display device attached to each of the exterior mirrors that is actuated by a detection signal received from either one of the sensors that detects a presence of a second vehicle in one of the blind spot location areas;
a first video camera assembled to the right side exterior mirror, wherein the first video camera generates a first video image signal;
a second video camera assembled to the left side exterior mirror, wherein the second video camera generates a second video image signal;
a video display screen visible to a driver of the vehicle that is actuated by a turn indicator actuation signal, wherein at least one of the first video image signal and second video image signal is displayed on the video display screen; and
wherein when a second vehicle is detected by the first sensor, the visual alert display device in the right side exterior mirror is actuated, and wherein when a second vehicle is detected by the second sensor, the visual alert display device in the left side exterior mirror is actuated.

21. The vehicle accessory of claim 20 visual alert display is illuminated when a second vehicle is in the blind spot location areas, and wherein the video display screen projects an image received from one of the video cameras when the turn indicator actuation signal is received.

22. The vehicle accessory of claim 20 further comprising an audible alarm that is actuated when a second vehicle is detected by either one of the first sensor and the second sensor.

23. The vehicle accessory of claim 20 further comprising a manual switch that provides an alternative signal for selectively actuating or disabling the first video camera and the second video camera.
